(19) United States
(12) Patent Application Publication
(10) Pub. No.: US 2014/0036528 A1
(43) Pub. Date: Feb. 6, 2014

(54) LIGHT GUIDING PLATE, MANUFACTURING METHOD THEREOF, AND BACKLIGHT UNIT INCLUDING LIGHT GUIDING PLATE

(71) Applicant: SAMSUNG DISPLAY CO., LTD., Yongin-City (KR)

(72) Inventors: Seung-Mo KIM, Seongnam-si (KR); Dong Hoon KIM, Suwon-si (KR); Seung Hwan CHUNG, Asan-si (KR); Young Jun CHOI, Busan (KR); Jin Sung CHOI, Cheonan-si (KR)

(73) Assignee: SAMSUNG DISPLAY CO., LTD., Yongin-City (KR)

(21) Appl. No.: 13/674,432

(22) Filed: Nov. 12, 2012

(30) Foreign Application Priority Data
Jul. 31, 2012 (KR) 10-2012-0083911

(51) Int. Cl. G02B 6/26; B05D 5/06; F21V 8/00

(52) U.S. Cl. CPC G02B 6/26; G02B 6/0011; B05D 5/06
USPC 362/606; 385/31; 427/162

(57) ABSTRACT

A light guiding plate includes: a light guiding substrate; and a plurality of optical scattering patterns positioned on a first surface of the light guiding substrate. The plurality of optical scattering patterns respectively includes a binder, a scattering particle and a semiconductor nanocrystal. A color of light emitted from the plurality of optical scattering patterns is substantially the same.

This application claims priority to Korean Patent Application No. 10-2012-0083911 filed on Jul. 31, 2012, and all the benefits accruing therefrom under 35 U.S.C. §119, the entire contents of which are incorporated herein by reference.

### BACKGROUND

(a) Field

The invention relates to a light guiding plate, a manufacturing method thereof, and a backlight unit including the light guiding plate.

(b) Description of the Related Art

Flat panel displays are classified into a self-light-emitting display device that emits its own light to display an image, and a passive (non-emissive) display device that does not emit light itself and requires a light source. The self-light-emitting display device includes a light emitting diode (“LED”) display device, a field emissive display (“FED”) device, a vacuum fluorescent display (“VFD”) device, and a plasma display panel (“PDP”). The passive display device includes a liquid crystal display (“LCD”) device and an electrophoretic display device.

The display device including an additional light source among the passive display device may be a transmissive type, and includes a display panel displaying an image, and a backlight unit supplying light to the display panel. The backlight unit may include a light source module for generating light, and several optical sheets. The light source module may include at least one light source (otherwise referred to as a light emitting member). The light source may include a cold cathode fluorescent lamp (“CCFL”), a flat fluorescent lamp (“FFL”), and a LED. The LED is advantageous as having a low power consumption and generating a small amount of heat.

The backlight unit can uniformly irradiate light to a rear surface of the display panel, and may be classified as a direct type of backlight unit or an edge type of backlight unit according to a position of the light source in the backlight unit. Among them, the edge type of backlight unit is used in a manner where the light source module is provided on one side or more than one side of a light guiding plate, and light diffused through the light guiding plate is indirectly radiated on the display panel.

A semiconductor nanocrystal (referred to as a quantum dot) is a semiconductor material having a crystalline structure with a size of several nanometers, and includes several hundred to several thousand atoms. A size of the semiconductor nanocrystal is very small such that a surface area per unit volume is large and a quantum confinement effect appears. Accordingly, unique physical and chemical characteristics that are different from the corresponding original characteristics of the semiconductor material appear.

Particularly, a characteristic of a photoelectron of the nanocrystal may be controlled through a method of controlling the size thereof. Consequently, the semiconductor nanocrystal has been developed in applications such as for an element of the display device or a biolight-emitting device. For a semiconductor nanocrystal having excellent characteristics and various application possibilities, various composite techniques have been developed by controlling the size, the structure and uniformity thereof. Particularly, a method of increasing emitting efficiency and color purity has been developed by using the semiconductor nanocrystal in the display device.

### SUMMARY

One or more exemplary embodiment the invention provides a light guiding plate that increases color reproducibility, a manufacturing method thereof, and a backlight unit including the light guiding plate.

One or more exemplary embodiment of the invention increases transmittance of the backlight unit.

One or more exemplary embodiment of the invention reduces a manufacturing cost of the light guiding plate.

An exemplary embodiment of a light guiding plate according to the invention includes: a light guiding substrate; and a plurality of optical scattering patterns on a first surface of the light guiding substrate. The plurality of optical scattering patterns respectively includes a binder, a scattering particle and a semiconductor nanocrystal. A color of light emitted from the plurality of optical scattering patterns is substantially the same.

The plurality of optical scattering patterns may respectively further include a plurality of semiconductor nanocrystals. A first semiconductor nanocrystal may emit light of a first color and a second semiconductor nanocrystal may emit light of a second color different from the first color.

The light guiding substrate may transmit light of a third color different from the first color and the second color.

The first surface of the light guiding substrate may be substantially flat.

An exemplary embodiment of a backlight unit according to the invention includes: a light guiding substrate; a plurality of first optical scattering patterns positioned on a first surface of the light guiding substrate; and a light source positioned near a second surface of the light guiding substrate different from the first surface. The plurality of first optical scattering patterns respectively includes a binder, a scattering particle and a semiconductor nanocrystal. A color of light emitted from the plurality of first optical scattering patterns is the substantially same.

The plurality of first optical scattering patterns may include a plurality of semiconductor nanocrystals. A first semiconductor nanocrystal may emit light of a first color and a second semiconductor nanocrystal may emit light of a second color different from the first color.

The light guiding substrate may transmit light of a third color different from the first color and the second color.

The first surface of the light guiding substrate may be substantially flat.

The backlight unit may further include a plurality of second optical scattering patterns positioned on a third surface of the light guiding substrate facing the first surface of the light guiding substrate.

Light may be emitted from the first surface of the light guiding substrate.

The light guiding substrate may further include a third surface opposite to the first surface, and light may be emitted from the third surface of the light guiding substrate.

An exemplary embodiment of a manufacturing method of a light guiding plate according to the invention includes: providing a light guiding substrate; and forming a plurality of optical scattering patterns on a first surface of the light guiding substrate. The plurality of optical scattering patterns respectively includes a binder, a semiconductor in the binder, and a scattering particle. A color of light emitted from the plurality of optical scattering patterns is substantially the same.

The plurality of optical scattering patterns may include a plurality of semiconductor nanocrystals. A first semiconductor nanocrystal may emit light of a first color and a second semiconductor nanocrystal may emit light of a second color different from the first color.

The forming the plurality of optical scattering patterns may include inkjet-printing an ink on the light guiding substrate. The ink may include the binder, the scattering particle and the semiconductor nanocrystal.

The forming the plurality of optical scattering patterns may include providing an ink on the light guiding substrate by using a screen including a plurality of openings. The ink may include the binder, the scattering particle and the semiconductor nanocrystal.

The forming the plurality of optical scattering patterns may include filling the ink in the plurality of openings.

According to one or more exemplary embodiment of the invention, color reproducibility of light emitted from the light guiding plate may be increased, light emitting efficiency or transmittance of the backlight unit including the light guiding plate may be increased, and the manufacturing cost of the light guiding plate may be reduced.

### BRIEF DESCRIPTION OF THE DRAWINGS

The above and other features of this disclosure will become more apparent by describing in further detail exemplary embodiments thereof with reference to the accompanying drawings, in which:

FIG. 1 is a cross-sectional view of an exemplary embodiment of a light guiding plate and a light source according to the invention,

FIG. 2 is a perspective view of an exemplary embodiment of a display device including a backlight unit including a light guiding plate according to the invention,

FIG. 3 is a graph of a color coordinate of light emitted from an exemplary embodiment of a backlight unit including a light guiding plate according to the invention, and a color coordinate of a conventional backlight unit,

FIG. 4 is a cross-sectional view of another exemplary embodiment of a light source and a light guiding plate according to the invention,

FIG. 5 is a top plan view of the light source and the light guiding plate in FIG. 4,

FIG. 6 is a cross-sectional view of still another exemplary embodiment of a light source and a light guiding plate according to the invention, FIG. 7 is a top plan view of the light source and the light guiding plate in FIG. 6,

FIG. 8 is a process cross-sectional view of an exemplary embodiment of a manufacturing method of a light guiding plate according to the invention, and

FIG. 9 is a process cross-sectional view of another exemplary embodiment of a manufacturing method of a light guiding plate according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “below” can encompass both an orientation of above and below.

The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

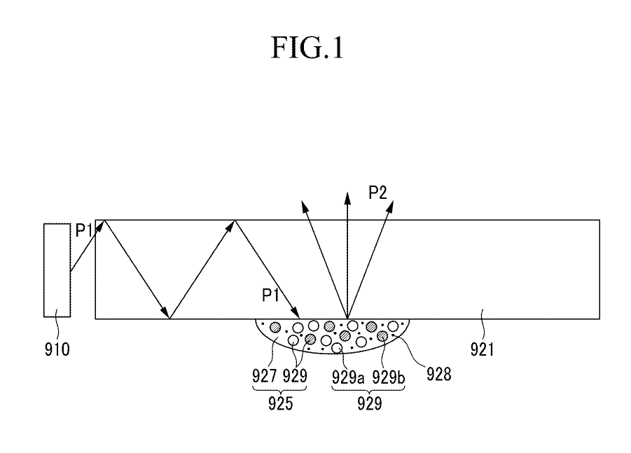

Firstly, an exemplary embodiment of a light guiding plate and a light source according to the invention will be described with reference to FIG. 1.

FIG. 1 is a cross-sectional view of an exemplary embodiment of a light guiding plate and a light source according to the invention.

Referring to FIG. 1, in an exemplary embodiment, a light source 910 is positioned at a side surface of a light guiding plate 920. The light guiding plate 920 includes an emitting surface through which light is emitted from the light guiding plate 920. An upper surface or a lower surface may be the emitting surface of the light guiding plate 920. The emitting surface may be referred to as a front surface. A surface opposite to the emitting (or front) surface is referred to as a rear surface of the light guiding plate 920. The side surface of the light guiding plate 920 is a surface different from both the front surface and the rear surface of the light guiding plate 920. The light guiding plate 920 may include a plurality of side surfaces which connect the front surface and the rear surface to each other.

The light source 910 includes at least one light emitting element. The light emitting element may include a light emitting diode (“LED”) chip, however, is not limited thereto. The light source 910 may emit a colored light, such as blue light, however, is not limited thereto. In exemplary embodiments, various colors such as a magenta color in which blue and red colors are mixed, a green color, or white color may be emitted by the light source 910. In one exemplary embodiment, the light source 910 may emit light in an ultraviolet ray region or spectrum.

The exemplary embodiment of the light guiding plate 920 according to the invention includes a transparent light guiding substrate 921, and an optical scattering pattern 925. The light guiding plate 920 may include a plurality of optical scattering patterns 925.

The light guiding substrate 921 may include a material such as poly(methyl methacrylate (“PMMA”), polycarbonate (“PC”), and polyethylene terephthalate (“PET”), but is not limited thereto or thereby. A refractive index of the light guiding substrate 921 may be larger than 1, and for example, may be in a range of about 1.4 to about 1.6.

As shown in FIG. 1, a plurality of optical scattering patterns 925 may be on one surface among a front surface or a rear surface of the light guiding substrate 921, and not on a side surface of the light guiding substrate 921. Alternatively, the plurality of optical scattering patterns 925 may be on both the front and rear surfaces of the light guiding substrate 921. The plurality of optical scattering patterns 925 may be separated from each other. The optical scattering pattern 925 may be a discrete and individual unit. The surface of the light guiding substrate 921 including the plurality of optical scattering patterns 925 thereon may be substantially flat, but is not limited thereto or thereby.

An exemplary embodiment of the optical scattering pattern 925 according to the invention includes a binder 927, and a mixture of scattering particles 928 and semiconductor nanocrystal 929 in the binder 927.

The binder 927 may include a transparent material such as acryl, urethane and epoxy resin, but is not limited thereto or thereby.

The scattering particles 928 may include a transparent material such as titanium dioxide (TiO₂) or silica-based nanoparticles. A refractive index of the scattering particles 928 may be larger than a refractive index of the binder 927, for example, in a range of about 1.41 to about 3.0.

Referring again to FIG. 1, light P1 is emitted from the light source 910, is incident to the light guiding substrate 921, and is then totally reflected and progressed within the light guiding substrate 921 to be incident into the optical scattering pattern 925. The light is scattered by a refractive index difference between the binder 927 and the scattering particles 928 within the optical scattering pattern 925 and is emitted from the light guiding plate 920 through the emitting surface as scattered light P2. Accordingly, a path of the light P1 incident from the side surface of the light guiding plate 920 is changed such that the light P1 may be ultimately emitted to the front surface of the light guiding plate 920.

A diameter or width of the scattering particle 928 may be equal to or less than about 5 micrometers (μm). A concentration of the scattering particles 928 within the optical scattering pattern 925 may be in a range of about 0.01 weight percent (wt %) to about 20 wt %, based on a total weight of the optical scattering pattern 925, but is not limited thereto.

The semiconductor nanocrystal 929, also referred to as quantum dots, is a semiconductor material having a crystallization structure of a nanosize. The semiconductor nanocrystal 929 is excited by irradiation of the light P1 thereto, thereby changing and emitting a wavelength of the irradiated light P1. In one exemplary embodiment, for example, a green emitting semiconductor nanocrystal receives light thereby emitting green light, and red emitting semiconductor nanocrystal receives light thereby emitting light red. The light emitted from the semiconductor nanocrystal 929 has a narrow band width and excellent color purity.

A diameter of the semiconductor nanocrystal 929 may be in a range of about 3 nanometers (nm) to about 10 nm, but is not limited thereto.

In an exemplary embodiment, each particle may have a core/shell structure having one or more shells in which a first semiconductor nanocrystal is surrounded by a second semiconductor nanocrystal. The core and shell may have an interface, and an element of at least one of the core or the shell may have a concentration gradient that decreases in a direction from the surface of the particle to a center of the particle.

The semiconductor nanocrystal 929 may include a core including a group II-VI semiconductor, a group III-V semiconductor, a group IV semiconductor or a group IV-VI semiconductor. The semiconductor nanocrystal 929 may include at least one shell enclosing the core, and the shell may include a group II-VI semiconductor, a group III-V semiconductor, a group IV semiconductor, or a group IV-VI semiconductor. The term “group” refers to a group of the Periodic Table of Elements.

The Group II-VI compound includes a Group II element and a Group VI element, and may include a binary compound selected from CdSe, CdTe, ZnS, ZnSe, ZnTe, ZnO, HgS, HgSe, HgTe, MgSe, MgS, and a combination thereof; a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; or a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof. The Group III-V compound includes a Group III element and a Group V element, and may include a binary compound selected from GaN, GaP, GaAs, GaSb, AlN, AlP, AlAs, AlSb, InN, InP, InAs, InSb, and a combination thereof; a ternary compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a combination thereof; or a quaternary compound selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and a combination thereof. The Group IV-VI compound includes a Group IV element and a Group VI element, and may include a binary compound selected from SnS, SnSe, SnTe, PbS, PbSe, PbTe, and a combination thereof; a ternary compound selected from SnSeS, SnSeTe, SnSTe, PbSeS, PbSeTe, PbSTe, SnPbS, SnPbSe, SnPbTe, and a combination thereof; or a quaternary compound selected from SnPbSSe, SnPbSeTe, SnPbSTe, and a combination thereof. The Group IV element includes Si, Ge, and a combination thereof. The Group IV compound may include a binary compound selected from SiC, SiGe, and a combination thereof.

Herein, the element, the binary compound, the ternary compound, or the quaternary compound may be present in a particle having a substantially uniform concentration, or may be present in a particle having different concentration distributions in the same particle. Thus a particle may have a gradient of the semiconductor, a concentration of the semiconductor may vary in a direction towards a center of the particle, the concentration may increase or decrease in a direction towards a center of the particle. The concentration may vary homogeneously or inhomogeneously.

Where the light P1 incident to the light guiding substrate 921, and totally reflected and progressed in the light guiding substrate 921, is incident to the optical scattering pattern 925, the wavelength of the light irradiated to the semiconductor nanocrystal 929 among the incident light is changed such that the light may be emitted outside the light guiding plate 920. The light emitted from the semiconductor nanocrystal 929 within the optical scattering pattern 925 may be again scattered by the scattering particles 928.

Accordingly, the color of the light P2 emitted from and/or the emission wavelength of the light guiding plate 920 may respectively be a color or a wavelength based on a mixture of the light P1 emitted from the light source 910 and the light emitted from the semiconductor nanocrystal 929. Accordingly, the wavelength of the light emitted from the light source 910 and the wavelength of the light emitted from the semiconductor nanocrystal 929 are controlled to control the wavelength region of the light emitted from the light guiding plate 920. In one exemplary embodiment, for example, the wavelength of the light emitted from the light source 910 and the wavelength of the light emitted from the semiconductor nanocrystal 929 may be controlled such that the light emitted from the light guiding plate 920 may display white light.

Referring again to FIG. 1, an exemplary embodiment of the semiconductor nanocrystal 929 included in the optical scattering pattern 925 according to the invention may include a first color semiconductor nanocrystal 929a and a second color semiconductor nanocrystal 929b. Here, the first color and the second color are different colors, but are not limited thereto or thereby. In one exemplary embodiment, for example, where the color of the light emitted from the light source 910 is blue, the first color of the semiconductor nanocrystal may be red and the second color of the semiconductor nanocrystal may be green. Accordingly, the light P2 scattered and emitted in the optical scattering pattern 925 may be the white light of which the light of blue, red and green is mixed.

A kind and content of the semiconductor nanocrystal 929 included in the plurality of optical scattering patterns 925 included in the light guiding plate 920 may be uniform. In one exemplary embodiment, sizes or dimensions of the semiconductor nanocrystal 929 may be substantially the same within the optical scattering patterns 925. Accordingly, the color and the luminance of the light emitted from the light guiding plate 920 may be uniform according to uniform semiconductor nanocrystal 929 and an arrangement of the optical scattering patterns 925.

An exemplary embodiment of the optical scattering pattern 925 according to the invention may further include a barrier (not shown) preventing penetration of moisture from outside the optical scattering pattern 925 to improve reliability of the optical scattering pattern 925 and the light guiding plate 920 including the optical scattering pattern 925. The barrier may enclose the binder 927. That is, the barrier may form an outermost layer of the optical scattering pattern 925, but is not limited thereto or thereby.

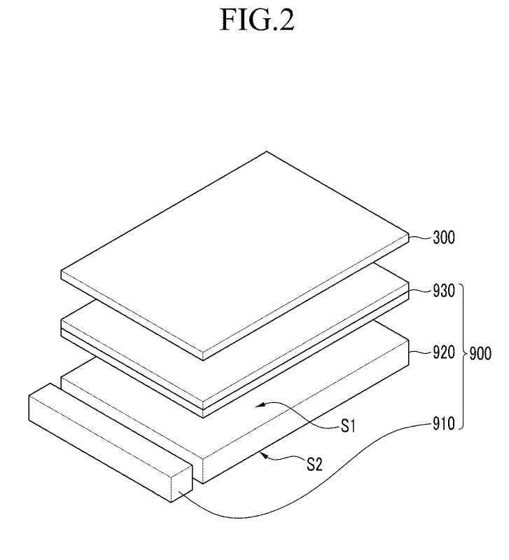

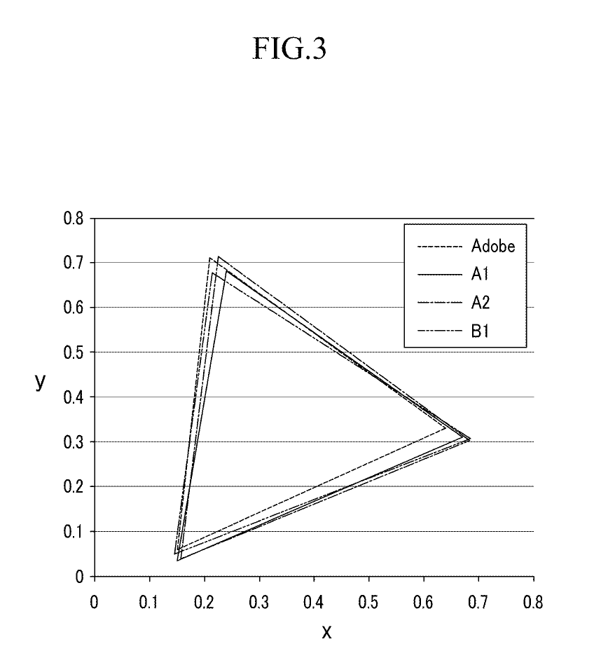

Next, a backlight unit and a display device including a light guiding plate and a light source will be described with reference to FIG. 2 and FIG. 3.

FIG. 2 is a perspective view of an exemplary embodiment of a display device including a backlight unit including a light guiding plate according to the invention, and FIG. 3 is a graph of a color coordinate of light emitted from an exemplary embodiment of a backlight unit including a light guiding plate according to the invention, and a color coordinate of a conventional backlight unit.

Referring to FIG. 2, an exemplary embodiment of a display device according to the invention may include a display panel 300, and a backlight unit 900 positioned at a rear surface of the display panel 300.

The display panel 300 may include a plurality of pixels (not shown), and a panel driver (not shown) to apply a driving signal to the pixels.

The backlight unit 900 includes the exemplary embodiment of the light source 910 and the light guiding plate 920 according to the invention, and may further include at least one optical sheet 930.

The light source 910 may be disposed to be close or adjacent to the side surface of the light guiding plate 920, thereby providing an edge type of backlight unit 900. However, the backlight unit 900 is not limited thereto or thereby.

The light guiding plate 920 guides the light emitted from the light source 910 toward the display panel 300. The plurality of optical scattering patterns 925 included in the light guiding plate 920 may be positioned on the first surface S1 facing the display panel 300 or the second surface S2 opposite to the first surface S1 among the surfaces of the light guiding plate 920. Alternatively, the plurality of optical scattering patterns 925 may be positioned on both of the first surface S1 and the second surface S2 of the light guiding plate 920. The light that is scattered in the optical scattering patterns 925 of the light guiding plate 920 and scattered toward the second surface S2 is reflected by a reflection member (not shown) that is separately provided at a rear side of the backlight unit 900, thereby being directed again toward the display panel 300.

The optical sheet 930 may include a diffuser sheet (not shown), and a prism sheet (not shown) positioned on the light guiding plate 920. The optical sheet 930 uniformly diffuses the light emitted from the light guiding plate 920 to improve luminance and uniformity of the light.

The light emitted from the backlight unit 900 including the exemplary embodiment of the light guiding plate 920 according to the invention has high color reproducibility. Referring to FIG. 3, a color space of red, green and blue (RGB) primary colors of the light emitted from an first backlight unit A1 and a second backlight unit A2 including an exemplary embodiment of the light guiding plate 920 according to the invention is very wide, and may be substantially in accordance with an Adobe RGB color space. Accordingly, the color space of the image displayed in a display device using an exemplary embodiment of the backlight unit according to the invention is wide thereby increasing the color reproducibility within the display device.

In contrast, the color space of the RGB primary color of the light emitted from a conventional backlight unit B1 using a LED including a phosphor is narrower than the color space of the light emitted from the first and the second backlights A1 and A2 according to the invention, and a matching ratio with the Adobe RGB color space is lower than that of the first and the second backlights A1 and A2.

According to an exemplary embodiment of the invention, the semiconductor nanocrystal 929 included in the light guiding plate 920 is included in a partial region of the light guiding plate 920, that is, within the optical scattering patterns 925. As a result, an amount of the semiconductor nanocrystal 929 used may be significantly reduced as compared when the semiconductor nanocrystal 929 is on an entire surface of the light guiding plate 920 such as in the form of an additional sheet. Accordingly, the manufacturing cost of the light guiding plate 920 may be reduced, and simultaneously, transmittance and light emitting efficiency of the light emitted from the light source 910 may be increased. Also, an amount of environment-polluting material from a raw material of the semiconductor nanocrystal 929 such as cadmium (Cd), may be reduced.

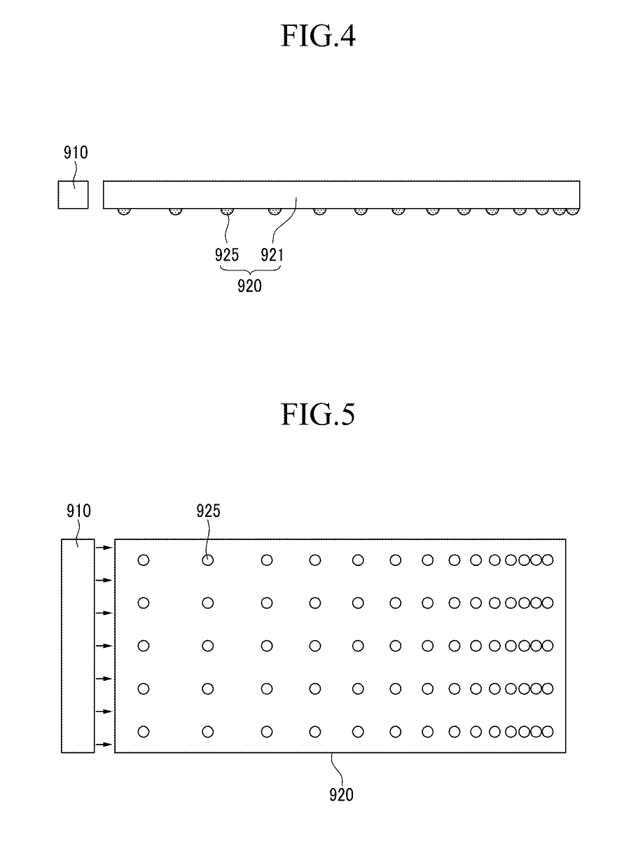

Next, exemplary embodiments of a light guiding plate according to the invention will be described with reference to FIG. 4 to FIG. 7. The same constituent elements as in the exemplary embodiment shown in FIG. 1 are indicated by the same reference numerals, and the same description is omitted.

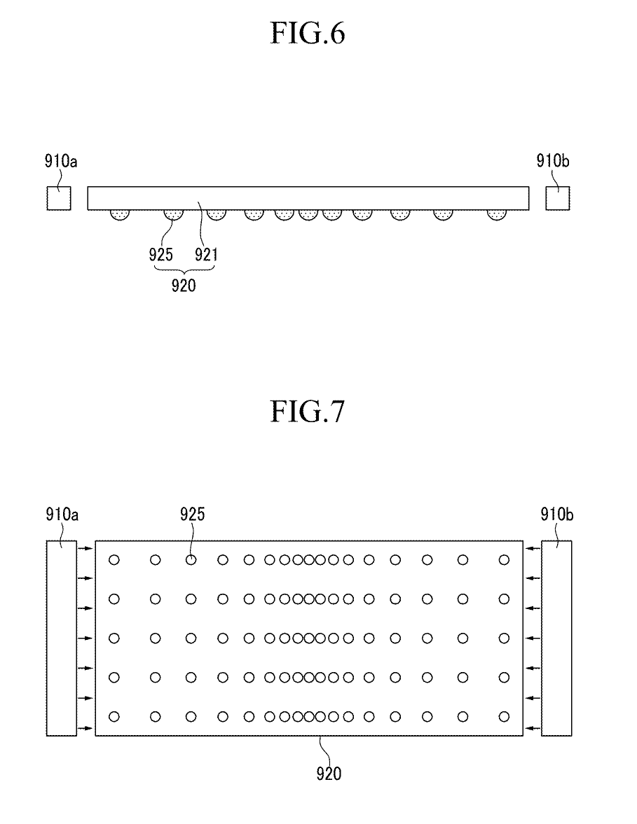

FIG. 4 is a cross-sectional view of another exemplary embodiment of a light source and a light guiding plate according to the invention, FIG. 5 is a top plan view of the light source and the light guiding plate in FIG. 4, FIG. 6 is a cross-sectional view of still another exemplary embodiment of a light source and a light guiding plate according to the invention, and FIG. 7 is a top plan view of the light source and the light guiding plate in FIG. 6.

Firstly, referring to FIG. 4 and FIG. 5, another exemplary embodiment of a light guiding plate 920 according to the invention may include the optical scattering pattern 925 and the light guiding substrate 921 similar to the exemplary embodiment of the light guiding plate 920 in FIG. 1, and the light source 910 may be positioned at one side surface of the light guiding substrate 921.

A cross-sectional thickness of the light guiding substrate 921 may be substantially uniform, but is not limited thereto or thereby. Alternatively, the light guiding substrate 921 may have a non-uniform thickness, such as a wedge-shape. The light guiding plate 920 in FIGS. 4 and 5 includes a plurality of discrete optical scattering patterns 925. A distribution density of the optical scattering patterns 925 may increase as a distance from the one side surface at which the light source 910 is disposed increases. As the emitted light close to the light source 910 is strong, the density of the optical scattering patterns 925 decreases adjacent to the light source 910 to reduce a reflection amount of the light, and the density of the optical scattering patterns 925 increases as the optical scattering patterns 925 are farther away from the light source 910 to increase the reflection amount of the light such that the light emitted through and from a front (e.g., emitting) surface of the light guiding plate 920 may be uniform.

Referring to FIG. 6 and FIG. 7, still another exemplary embodiment of a light guiding plate 920 according to the invention includes an optical scattering pattern 925 and a light guiding substrate 921 as described above. A plurality of light sources, such as a pair of light sources 910a and 910b, may be positioned at respective opposing sides of the light guiding substrate 921.

A cross-sectional thickness of the light guiding substrate 921 may be uniform between the opposing sides of the light guiding substrate 921. A center of the light guiding plate 920 may be defined substantially half way between the opposing sides. The light guiding plate 920 in FIGS. 4 and 5 includes a plurality of discrete optical scattering patterns 925. A distribution density of the optical scattering patterns 925 may increase as a distance from the opposing sides towards the center increases. Since the light sources 910a and 910b are disposed at the respective opposing sides of the light guiding plate 920, the density of the optical scattering patterns 925 increases in a direction away from the light sources 910a and 910b to increase the reflection of the light such that the light emitted from the front (e.g., emitting) surface of the light guiding plate 920 may be uniform.

Also, the density and the arrangement of the optical scattering pattern 925 formed in the light guiding plate 920 may be variously changed.

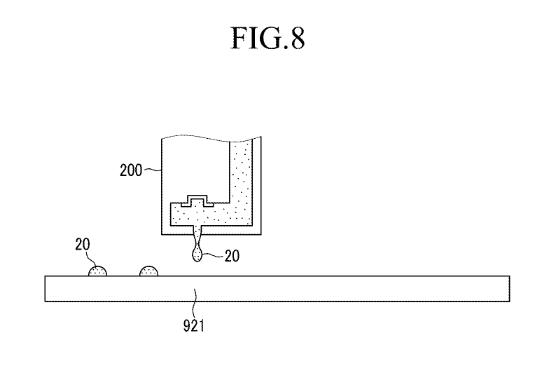

Next, an exemplary embodiment of a manufacturing method of a light guiding plate according to the invention will be described with reference to FIG. 8.

FIG. 8 is a process cross-sectional view of an exemplary embodiment of a manufacturing method of a light guiding plate according to the invention.

Referring to FIG. 8, a transparent light guiding substrate 921 is provided. In one exemplary embodiment, the light guiding substrate 921 may be manufactured by a method such as extrusion molding or injection molding.

A plurality of drops of optical scattering pattern ink 20 is deposited on the light guiding substrate 921 such as by using an inkjet printer 200. The inkjet printer 200 may include a cartridge including the optical scattering pattern ink 20.

The optical scattering pattern ink 20 includes a mixture of a binder 927, scattering particles 928 and a semiconductor nanocrystal 929.

The optical scattering pattern ink 20 deposited onto the light guiding substrate 921 is hardened such as through thermal hardening or ultraviolet ray hardening, to form a plurality of optical scattering patterns 925.

According to another exemplary embodiment of the invention, the optical scattering pattern ink 20 deposited on the light guiding substrate 921 may include a solvent. If the solvent of the optical scattering pattern ink 20 is volatilized, a plurality of optical scattering patterns 925 according to the invention may be formed.

According to an exemplary embodiment of the invention, a size of the optical scattering pattern 925 may be controlled by controlling the amount of optical scattering pattern ink 20 discharged from the inkjet printer 200.

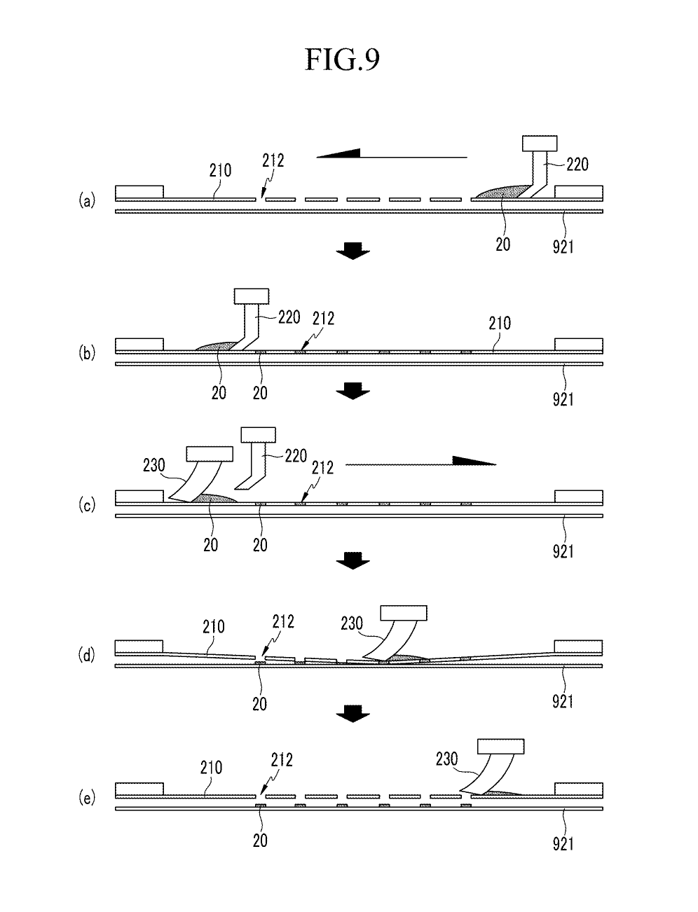

Next, another exemplary embodiment of a manufacturing method of a light guiding plate according to the invention will be described with reference to FIG. 9.

FIG. 9 is a cross-sectional view of a process of another exemplary embodiment of a manufacturing method of a light guiding plate according to the invention.

Referring to FIG. 9(a), a light guiding substrate 921 is provided, and a screen 210 including a plurality of openings 212 is provided to overlap the light guiding substrate 921. The plurality of openings 212 of the screen 210 may have an arrangement shape corresponding to an arrangement of the optical scattering patterns 925 for a final light guiding plate 920.

An optical scattering pattern ink 20 including a mixture of the binder 927, the scattering particles 928 and the semiconductor nanocrystal 929 is provided. Referring FIG. 9(b), the optical scattering pattern ink 20 is applied across the screen 210 such as by using a scraper 220 to fill the optical scattering pattern ink 20 in the plurality of openings 212 of the screen 210. The scraper 220 may move in a right-to-left direction as indicated by the arrow in FIG. 9(b), but is not limited thereto or thereby.

Referring to FIG. 9(c) and FIG. 9(d), the optical scattering pattern ink 20 filled in the openings 212 of the screen 210 is removed from openings 212 and transferred onto the light guiding substrate 921 such as by using a blade 230. The blade 230 may move in a left-to-right direction as indicated by the arrow in FIG. 9(c), but is not limited thereto or thereby.

Referring to FIG. 9(e), a plurality of optical scattering pattern ink 20 portions is positioned on the light guiding substrate 921. The optical scattering pattern ink 20 discharged onto the light guiding substrate 921 is hardened such as through thermal hardening or ultraviolet ray hardening, to form a plurality of optical scattering patterns 925.

In an exemplary embodiment of the invention, a size of the optical scattering patterns 925 may be controlled by controlling the size of the openings 212 of the screen 210.

According to another exemplary embodiment of the invention, the optical scattering pattern ink 20 transferred to the light guiding substrate 921 may include a solvent. If the solvent included in the optical scattering pattern ink 20 is volatilized, a plurality of optical scattering patterns 925 according to the invention may be formed.

According to another exemplary embodiment of the invention, the manufacturing process shown in FIG. 9(a) and FIG. 9(b) may be omitted. That is, the optical scattering pattern ink 20 may be moved on the screen 210 including a plurality of openings 212 to directly transfer the optical scattering pattern ink 20 to the light guiding substrate 921 through the openings 212.

According to one or more exemplary embodiment of a manufacturing method of the light guiding plate 920 according to the invention, the optical scattering pattern 925 including the semiconductor nanocrystal 929 is formed in a partial region of the light guiding plate 920 such that an amount of the semiconductor nanocrystal 929 may be significantly reduced and the manufacturing cost of the light guiding plate 920 may be reduced. Also, an amount of environment-polluting material from a raw material of the semiconductor nanocrystal 929 such as cadmium (Cd), may be reduced.

While this invention has been described in connection with what is presently considered to be practical exemplary embodiments, it is to be stood that the invention is not limited to the disclosed embodiments, but, on the contrary, is intended to cover various modifications and equivalent arrangements included within the spirit and scope of the appended claims.

What is claimed is:

1. A light guiding plate comprising:
a light guiding substrate; and
a plurality of optical scattering patterns on a first surface of the light guiding substrate,
wherein the plurality of optical scattering patterns respectively comprises a binder, a scattering particle and a semiconductor nanocrystal, and
wherein a color of light emitted from the plurality of optical scattering patterns is substantially the same.

2. The light guiding plate of claim 1, wherein
the plurality of optical scattering patterns respectively further comprises a plurality of semiconductor nanocrystals, and
a first semiconductor nanocrystal emits light of a first color, and a second semiconductor nanocrystal emits light of a second color different from the first color.

3. The light guiding plate of claim 2, wherein
the light guiding substrate transmits light of a third color different from the first color and the second color.

4. The light guiding plate of claim 3, wherein
the first surface of the light guiding substrate is substantially flat.

5. A backlight unit comprising:
a light guiding substrate;
a plurality of first optical scattering patterns on a first surface of the light guiding substrate; and
a light source adjacent to a second surface of the light guiding substrate different from the first surface,
wherein the plurality of first optical scattering patterns respectively comprises a binder, a scattering particle and a semiconductor nanocrystal, and
wherein a color of light scattered emitted from the plurality of first optical scattering patterns is the substantially same.

6. The backlight unit of claim 5, wherein
the plurality of first optical scattering patterns respectively further comprises a plurality of semiconductor nanocrystals, and
a first semiconductor nanocrystal emits light of a first color, and a second semiconductor nanocrystal emits light of a second color different from the first color.

7. The backlight unit of claim 6, wherein
the light guiding substrate transmits light of a third color different from the first color and the second color.

8. The backlight unit of claim 7, wherein
the first surface of the light guiding substrate is substantially flat.

9. The backlight unit of claim 8, further comprising
a plurality of second optical scattering patterns on a third surface of the light guiding substrate facing the first surface of the light guiding substrate.

10. The backlight unit of claim 8, wherein
light is emitted from the light guiding substrate through the first surface.

11. The backlight unit of claim 8, wherein
the light guiding substrate comprises a third surface opposite to the first surface, and
light is emitted from the third surface of the light guiding substrate.

12. The backlight unit of claim 5, further comprising
a plurality of second optical scattering patterns on a third surface of the light guiding substrate facing the first surface.

13. The backlight unit of claim 5, wherein
light is emitted from the first surface of the light guiding substrate.

14. The backlight unit of claim 5, wherein
the light guiding substrate comprises a third surface opposite to the first surface, and
light is emitted from the third surface of light guiding plate.

15. A method of manufacturing a light guiding plate, the method comprising:
providing a light guiding substrate; and
forming a plurality of optical scattering patterns on a first surface of the light guiding substrate,
wherein the plurality of optical scattering patterns respectively comprises a binder, a scattering particle and a semiconductor nanocrystal, and
wherein a color of light emitted from the plurality of optical scattering patterns is substantially the same.

16. The method of claim 15, wherein
the plurality of optical scattering patterns respectively further comprises a plurality of semiconductor nanocrystals, and
a first semiconductor nanocrystal emits light of a first color, and a second semiconductor nanocrystal emits light of a second color different from the first color.

17. The method of claim 16, wherein
the forming the plurality of optical scattering patterns comprises inkjet-printing an ink on the light guiding substrate, the ink comprising the binder, the scattering particle and the semiconductor nanocrystal.

18. The method of claim 16, wherein
the forming the plurality of optical scattering patterns comprises providing an ink on the light guiding substrate via a screen comprising a plurality of openings, the ink comprising the binder, the scattering particle, and the semiconductor nanocrystal.

19. The method of claim 18, wherein
the forming the plurality of optical scattering patterns comprises filling the ink in the plurality of openings of the screen.
